(19) United States
(12) Patent Application Publication
(10) Pub. No.: US 2026/0048762 A1
(43) Pub. Date: Feb. 19, 2026

(54) COMPUTER-IMPLEMENTED METHOD AND SYSTEM FOR PLANNING THE BEHAVIOR OF A VEHICLE IN A TRAFFIC SCENE

(71) Applicant: Robert Bosch GmbH, Stuttgart (DE)

(72) Inventors: Max Keller, Berlin (DE); Benjamin Voelz, Leonberg (DE); Christian Weiss, Lossburg (DE); Marcel Hallgarten, Ehningen (DE); Marvin Klimke, Altena (DE); Maxim Dolgov, Renningen (DE); Michael Hanselmann, Korntal-Muenchingen (DE)

(21) Appl. No.: 19/293,004

(22) Filed: Aug. 7, 2025

(30) Foreign Application Priority Data
Aug. 15, 2024 (DE) 10 2024 207 779.8

(51) Int. Cl. B60W 60/00; G01C 21/34; G05D 1/622

(52) U.S. Cl. CPC B60W 60/001; G01C 21/3461; G05D 1/637

(57) ABSTRACT

A computer-implemented method and system for planning the behavior of a vehicle in a traffic scene. The behavior planning pursues a specified destination. The system includes a perception level for aggregating scene-specific information and for generating at least one scene representation of the traffic scene, a neural network which carries out strategic behavior planning based on the scene representation generated by the perception level, and a downstream planning component which carries out detailed behavior planning based on the strategic behavior planning. The neural network is trained to generate a geometric behavior specification for the vehicle in the given traffic scene as a result of the strategic behavior planning. For this purpose, the neural network identifies at least one go zone that the vehicle may or should pass through to pursue the specified destination, and/or at least one no-go zone that the vehicle should avoid when pursuing the specified destination.

### CROSS REFERENCE

The present application claims the benefit under 35 U.S.C. § 119 of German Patent Application No. DE 10 2024 207 779.8 filed on Aug. 15, 2024, which is expressly incorporated herein by reference in its entirety.

### FIELD

The present invention relates to a computer-implemented method and to a computer-implemented system for planning the behavior of a vehicle in a traffic scene, wherein the behavior planning pursues a specified destination. The destination may, for example, be a target location but also an intended route or a combination of target location and intended route, such as “Drive from A to B and use only country roads.”

### BACKGROUND INFORMATION

The task of autonomous driving is to control an ego vehicle on the basis of aggregated scene-specific information, in particular on the basis of sensor data, such as radar signals, lidar signals, RGB camera signals, such that a destination is reached as quickly, comfortably, and safely as possible. Among other things, traffic rules should be observed and collisions with infrastructure elements and/or other participants in the traffic scene should be avoided. This driving task can be divided into the subtasks of perception, prediction, planning, and control.

The task of perception is to extract relevant information, such as location and state information about static and dynamic objects in the traffic scene, in particular about other road users, from the aggregated scene-specific information. Furthermore, at the perception level, road markings can be identified and traffic signs or similar can be recognized and compared with map data. In this way, an environmental model is generated as a scene representation of the current traffic scene.

Prediction is used to estimate the future development of the traffic scene, in particular the behavior of other participants in the traffic scene and of dynamic objects.

The planning uses the environmental model and the prediction of the future development of the traffic scene to plan the future behavior of the ego vehicle.

Conventional planning methods can essentially be divided into three categories: classical planning methods, which include in particular rule-based, sampling-based, tree-search-based, and optimization-based planning methods; learned planning methods; and hybrid planning methods, which are realized in the form of a combination of classical and learned methods. In recent years, the use of machine learning, in particular deep learning (DL), has become the de facto standard in learned methods since it allows a wide range of context information and, in particular, interactions between the participants in a traffic scene to be included in the planning.

Planning is usually structured hierarchically. A strategic behavior planner makes abstract (high-level) decisions, which are then implemented by a downstream planning component as part of detailed planning. Strategic behavior planning is generally carried out at a lower frequency than the underlying detailed planning. The downstream planning component thus achieves the planning tasks that result from the strategic behavior planning.

As a result of the planning, and, in particular, the detailed planning, one or more trajectories that are suitable for the vehicle in question are often generated. Each trajectory comprises position data, possibly together with vehicle state data, for a specified number of successive points in time. The state data generally describe the movement state of the vehicle, such as velocity, acceleration, and/or orientation, at the particular point in time.

The result of the planning is then implemented with the aid of a controller by controlling the actuators of the vehicle accordingly. Trajectory data prove to be particularly advantageous for this purpose since they can usually be adjusted directly.

The present invention is based on a method and a system as described in the German Patent Application No. 10 2024 203 268.

Accordingly, at least one scene representation of the given traffic scene is generated on the basis of aggregated scene-specific information. The scene representation can be aggregated sensor data, a scene representation in the form of latent features, or even an environmental model of the given traffic scene derived therefrom. On the basis of the scene representation, strategic behavior planning is first carried out with the aid of at least one neural network. On the basis of the strategic behavior planning, detailed behavior planning is then carried out with the aid of at least one downstream planning component.

German Patent Application No. 10 2024 203 268 proposes using a text-based neural network, in particular a large language model (LLM), for the strategic behavior planning and carrying out the downstream detailed planning with the aid of a rule-based planning component. The qualitative behavior suggestion of the LLM is thus implemented quantitatively by the downstream rule-based planning component, viz., safely and conveniently, in a manner corresponding to the capabilities of the rule-based planning component.

The use of a text-based neural network for strategic behavior planning requires a “translation” of the scene representation into text queries, which can then be used as input for the text-based neural network. As a result of the strategic behavior planning, text-based behavior recommendations are generated, which also need to be “translated” so that they can be implemented by the downstream planning component.

### SUMMARY

According to an example embodiment of the present invention, it is provided to generate at least one geometric behavior specification for the vehicle in the given traffic scene as part of the strategic behavior planning by
identifying at least one go zone that the vehicle may or should pass through in order to pursue the specified destination, and/or by
identifying at least one no-go zone that the vehicle should avoid when pursuing the specified destination. As a result of the detailed behavior planning, at least one trajectory for the vehicle is then generated, taking into account the at least one geometric behavior specification of the strategic behavior planning.

These measures make it possible to use any unimodal or multimodal neural network for the strategic behavior planning. Unimodal or multimodal here refers to the modalities of the input data of the neural network. Thus, not only text data but also any perception data, such as sensor data from radar sensors, lidar sensors, video sensors, ultrasonic sensors, audio sensors, and/or images, and/or data from an environmental model, perception outputs, and prediction outputs can be used as input for the neural network.

The measures according to the present invention also allow the use of any downstream planning component for the detailed planning or for the implementation of the results of the strategic behavior planning.

According to the present invention, it has been found that any type of scenario or given traffic scene can be analyzed with regard to go zones and no-go zones and that, therefore, strategic behavior planning in the form of geometric behavior specifications for the vehicle can also be generated for any type of scenario or given traffic scene. Furthermore, it has been found according to the present invention that geometric behavior specifications can also be very easily taken into account in the detailed planning when planning trajectories, which are, after all, based on position/time coordinates.

In a preferred example embodiment of the present invention, a unimodal or a multimodal deep learning (DL) foundation model is used for the strategic behavior planning. Such a foundation model is very large and has been pre-trained with extremely large data sets, viz., usually in a self-supervised manner. Both the architecture of a foundation model and the training are generally non-task-specific. Most foundation models are based on transformer architectures. Overall, foundation models are characterized by a very good, global understanding of context in comparison to task-specific trained neural networks. Foundation models can therefore capture entire scenes at runtime on the basis of suitable input data and achieve tasks in the overall context of such a scene in a well-founded manner.

These capabilities of a foundation model are used here for the strategic behavior planning, which promotes good driving maneuver decisions appropriate to the situation. The deficits of foundation models with respect to geometric understanding and safety-relevant aspects of the traffic scene and with respect to the physical understanding of vehicle dynamics and vehicle specifics are compensated for by the combination with a downstream classical or DL-based planning component that has a good understanding of the physical capabilities of the vehicle, the geometry of the traffic scene, the necessary safety-relevant distances, etc. It is particularly advantageous if the downstream planning component also ensures compliance with the necessary traffic rules. Overall, this leads to safe, consistent, and human-like driving behavior.

As mentioned above, at least one geometric behavior specification for the vehicle in the given traffic scene is generated as part of the strategic behavior planning. For this purpose, at least one go zone is identified that the vehicle may or should pass through in order to pursue the specified destination, and/or at least one no-go zone that the vehicle should avoid when pursuing the specified destination.

In an advantageous example embodiment of the present invention, a sequence of hit points is generated as a geometric behavior specification as part of the strategic behavior planning, wherein each hit point is determined by location coordinates and a time specification and/or at least one state parameter for the vehicle. This may, in particular, be the vehicle velocity, vehicle acceleration, and/or vehicle orientation. Each hit point defined in this way represents a go zone that the vehicle should pass through when pursuing its destination. Accordingly, the hit points form support points for the at least one trajectory that is generated as part of the downstream detailed behavior planning. Since the strategic behavior planning is limited to high-level maneuver decisions, the number of hit points per time interval is significantly lower than the number of trajectory points generated as part of the detailed planning for the same time interval.

In a further advantageous example embodiment of the present invention, a sequence of hit regions is provided as a geometric behavior specification as part of the strategic behavior planning, wherein each hit region is determined by a location specification in the form of a polygon and a time interval and/or an interval of at least one state parameter for the vehicle. This is also, in particular, the vehicle velocity, the vehicle acceleration, and/or the vehicle orientation. Each hit region defined in this way represents a go zone that the vehicle may or should pass through when pursuing its destination. The at least one trajectory generated as part of the downstream detailed behavior planning should then pass through at least some of these hit regions or even lie exclusively within these hit regions.

In a particularly advantageous example embodiment of the present invention, the at least one geometric behavior specification is provided in the form of zones that are located in the traffic scene and to which semantic information on the possible behavior of the vehicle in the particular zone is assigned. The semantic information in particular includes conditions under which a zone may or may not be used. The possible behavior of the vehicle is described with the aid of at least one state parameter, in particular the velocity, acceleration, and/or orientation.

In this example embodiment of the present invention, the current traffic scene is analyzed with the aid of the neural network or the foundation model in order to reduce the traffic scene to a combination of situation-dependent zones, i.e., to geometric zones that are located in the traffic scene. In addition to the situation-dependent zones, the neural network or the foundation model provides semantic information in the form of restrictions to which the vehicle is subject within these zones, or conditions that the vehicle must fulfill in order to reach the next desired state. The result of this type of strategic behavior planning is also called geometric behaviors.

According to an example embodiment of the present invention, the strategic behavior planning is based on the scene representation of the given traffic scene. In addition, a prediction of the future development of the given traffic scene can also advantageously be taken into account.

This applies equally to the detailed behavior planning, which, according to the invention, is based on the strategic behavior planning. Advantageously, the scene representation of the given traffic scene and/or a prediction of the future development of the given traffic scene are also taken into account.

As mentioned above, both a classical and an ML-based planning component can be used for the downstream detailed behavior planning. It is essential that this planning component takes into account the physical conditions and capabilities of the vehicle as well as the scene geometry, i.e., the given distances and angles, in the detailed behavior planning, viz., in such a way that the abstract planning decisions of the strategic behavior planning are implemented into physically feasible and safe trajectories.

These trajectories can thus be generated in a rule-based, optimization-based, sampling-based, tree-search-based, or machine learning (ML)-based manner. In these cases, the at least one geometric behavior specification of the strategic behavior planning is advantageously taken into account as a selection criterion or as an optimization criterion when generating the at least one trajectory.

### BRIEF DESCRIPTION OF THE DRAWINGS

A computer-implemented method according to the present invention for planning the behavior of a vehicle and the corresponding computer-implemented system are explained in more detail below with reference to exemplary embodiments and advantageous developments in conjunction with the figures.

FIG. 1 illustrates a first example embodiment of a behavior planning system according to the present invention.

FIG. 2 illustrates an advantageous development of the behavior planning system 100 shown in FIG. 1.

### DETAILED DESCRIPTION OF EXAMPLE EMBODIMENTS

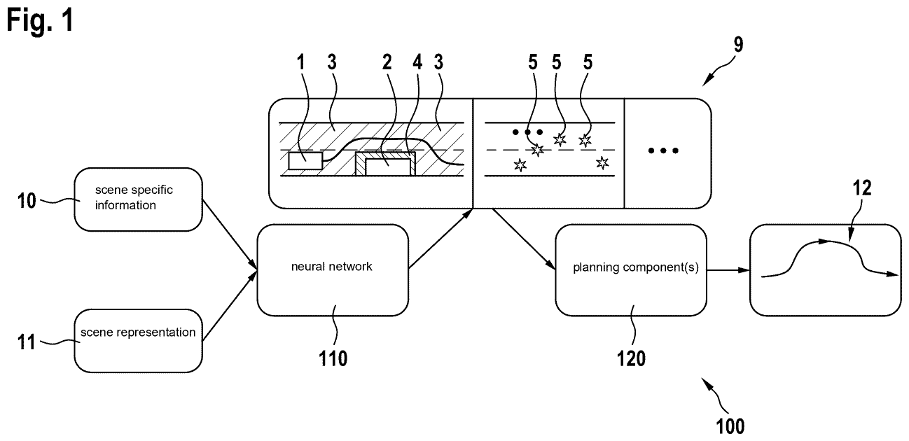

The block diagram of FIG. 1 illustrates the interaction of the individual components of a computer-implemented system 100 according to the invention for planning the behavior of a vehicle 1 in a traffic scene, wherein the behavior planning pursues a specified destination. The vehicle 1 is also referred to as the ego vehicle below.

The system 100 comprises a perception level, not shown in detail here, for aggregating scene-specific information 10 and for generating at least one scene representation 11 of the given traffic scene.

The starting point of the behavior planning is always the state of a traffic scene at a time of planning and in particular the state of all static and dynamic objects and participants in the traffic scene at the time of planning. The state of the traffic scene is described by scene-specific information that is aggregated from different sources of information at the time of planning or over a certain period of time before and up to the time of planning. The sources of information can be on-board sensors, such as lidar sensors, radar sensors, and/or RGB cameras installed on the ego vehicle, or off-board sensors, such as lidar sensors, radar sensors, and/or RGB cameras installed in or on infrastructure elements or other road users. Other sources of information include stored map information, possibly together with traffic rules, as well as queryable weather and road condition information and traffic situation information, etc. The information 10 from the different sources of information is aggregated and processed by the perception level in order to generate at least one scene representation. The aggregated scene-specific information 10 itself already represents a scene representation. However, with the aid of ML components, this information can also be further processed into a scene representation in latent space, for example. Based thereon, an environmental model 11 can also be generated as a scene representation, for example in the form of bird's-eye view images of the traffic scene, object lists, and/or occupancy grids. When generating such an environmental model, the results of a prediction of the future development of the traffic scene can also be taken into account.

According to the invention, the system 100 comprises a neural network 110 for strategic behavior planning. The input for the neural network 110 is at least one scene representation generated by the perception level. Here, both the aggregated scene-specific information 10 and an environmental model 11 generated therewith are provided to the neural network 110 as input. For the sake of completeness, it should be noted at this point that the input of the neural network 110 can also be preprocessed and/or fused by another ML component in order to bring the scene-specific information into the input representation required for the neural network 110.

In the preferred embodiment of the invention described here, the neural network 110 is a DL foundation model, which is always referred to below as the foundation model. The foundation model 110 was pre-trained in a non-task-specific manner with a very large amount of data and then retrained for the strategic planning in automated driving, which is called fine-tuning. This fine-tuning can be achieved through supervised learning. Training data that represent the desired output of the strategic planning are used for this purpose. Alternatively, such a foundation model can also be retrained using reinforcement learning in a customized simulation that also simulates the downstream detailed planning. A loss function that takes into account both the detailed behavior planning in the motion planning level and the strategic planning of the behavior of the foundation model on the basis of the simulated trajectories is optimized in this case. This allows the foundation model to independently learn the required output of the strategic behavior planning. The foundation model 110 can process input data from one or more modalities. It is particularly advantageous if the foundation model can utilize at least some of the different modalities of the aggregated scene-specific information.

According to the invention, the neural network, here the foundation model 110, is trained to generate at least one geometric behavior specification for the ego vehicle 1 in the given traffic scene as a result of the strategic behavior planning. For this purpose, at least one go zone 3 or 5 is identified that the ego vehicle 1 may or should pass through in order to pursue the specified destination. Alternatively or additionally, at least one no-go zone 4 is identified that the ego vehicle 1 should avoid when pursuing the specified destination.

This is illustrated by the schematic representations of a traffic scene in partial view 9. The left half of partial view 9 shows a traffic scene with an ego vehicle 1 moving toward an obstacle 2 in the right lane of a two-lane roadway. The foundation model 110 has analyzed this traffic scene and identified and located multiple go zones 3, shown here in shaded form, in the traffic scene. In addition, a no-go zone was identified in the immediate surroundings of the obstacle 4. The output of the foundation model 110 shown in the left half of partial view 9 corresponds to the concept of geometric behaviors described at the beginning.

The right half of partial view 9 illustrates another type of geometric behavior specification for the traffic scene described above with ego vehicle 1 and obstacle 2. The foundation model 110 here has generated a list of hit points 5, which can be interpreted as go zones since they should be traveled by the ego vehicle 1 when pursuing its destination and consequently form support points of the trajectory of the ego vehicle 1 to be planned. Here, a hit point is a tuple (x, y, t, v) of Cartesian coordinates x, y, an associated time t, and velocity v. The concept of hit points could also be extended to a concept of hit regions. The Cartesian point (x, y) of the hit point is replaced by a polygon P for hit regions. The individual velocity values and time values are also replaced by time intervals T and velocity intervals V.

Furthermore, according to the invention, the system 100 comprises at least one planning component 120 downstream of the neural network or foundation model 110, which planning component carries out detailed behavior planning on the basis of the strategic planning of the behavior of the neural network 110. This downstream planning component is configured to generate at least one trajectory 12 for the vehicle, taking into account the at least one geometric behavior specification of the strategic behavior planning.

It is essential that, in the downstream low-level motion planning level, i.e., in the detailed planning, specific boundary conditions that relate to the vehicle, i.e., its dynamics and dimensions, and traffic rules are taken into account. The input of the corresponding planning component is not limited to the output of strategic behavior planning. Without loss of generality, all input data of the foundation model 110 can also be used by the downstream planning component 120.

When using a sampling-based planning component 120, the geometric behavior specifications of the strategic behavior planning can be taken into account through cost conditions.

When using optimization-based planning components, such as model predictive control, black box optimization, etc., the geometric behavior specifications of the high-level planning can be taken into account through appropriate boundary conditions.

In control-based planning components, compliance with the geometric behavior specifications of the strategic behavior planning is ensured through open-loop and closed-loop control elements.

When using tree-search-based planning components, the geometric behavior requirements of the high-level planning are fulfilled as well as possible by appropriately selecting the branches when rolling out the tree.

ML-based planning components were trained by means of appropriate loss functions to comply with the behavior specifications of the high-level planning as well as possible.

At this point, it should be expressly pointed out that multiple of the planning components mentioned above can also be combined in the low-level motion planning level.

In general, it can be stated that the geometric behavior specifications according to the invention are very well suited for the evaluation of trajectories. The trajectories generated by a planning component can thus easily be evaluated with regard to their distance to the identified go zones or no-go zones. If the strategic behavior planning also provides semantic information about individual zones in the traffic scene, a specified set of rules, which prioritizes the trajectories, for example, with regard to safety and/or velocity, can also be used to evaluate the trajectories.

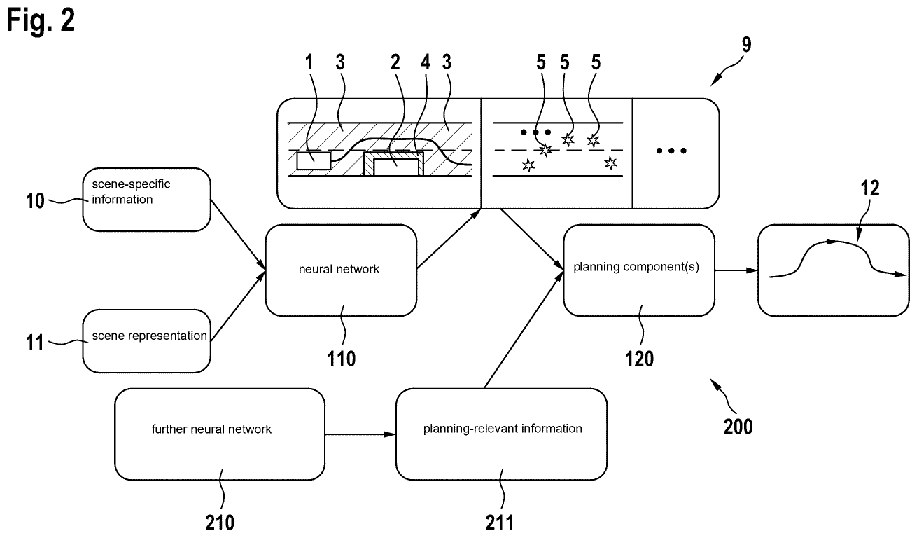

The system 200 shown in FIG. 2 is a development of the system 100 shown in FIG. 1. Therefore, identical components are provided with the same reference symbols. For an explanation of these components, reference is made to the description of FIG. 1.

In addition to the neural network 110 and the downstream planning component 120, the system 200 comprises a further neural network 210, which extracts planning-relevant information 211 from the aggregated scene-specific information and provides it to the downstream planning component 120.

In this development of the invention, the high-level strategic planning level comprises a further neural network 210 as a further high-level planning component in addition to the foundation model 110. Thus, the foundation model 110 could output only the spatial part of the hit regions/hit points and the further high-level planning component 210 could determine the temporal component of the hit regions/hit points on the basis of this output.

However, a constellation in which the further high-level planning component 210 is realized in the form of a classical planning component would also be conceivable. For example, it could also provide location information of a geometric behavior specification, while the foundation model 110 contributes corresponding time/velocity information.

The planning component 210 could also provide additional relevant planning output that is, for example, more accurate than the output of the foundation model. This could be achieved, for example, by a task-specific architecture and appropriate training of the neural network 210.

Possible realizations of such a neural network 210 and possible planning output could be, for example:
Safely navigable space that can be navigated in a fully compliant manner with the rules in the grid or polygon output format. This output format is easy to represent in terms of costs.
Realization: CNN that receives an environmental model in encoded form.
A velocity appropriate to the scene. Realization: MLP that receives an environmental model in encoded form. This output format is also easy to represent in terms of costs.

In conclusion, it can be stated that the measures according to the invention as part of the behavior planning for an at least partially automated vehicle contribute to better maneuver decisions that are appropriate to the situation and lead to safer, more consistent, and human-like driving behavior. The high context understanding of a unimodal or multimodal neural network, in particular a foundation model for the high-level maneuver planning, is used for this purpose, while the specific feasibility and physical realization of this strategic behavior planning is ensured by underlying ML-based or classical planning/control elements.

What is claimed is:

1. A computer-implemented method for planning a behavior of a vehicle in a given traffic scene, wherein the behavior planning pursues a specified destination, the method comprising the following steps:
generating at least one scene representation of the given traffic scene based on aggregated scene-specific information;
carrying out strategic behavior planning based on the scene representation using at least one neural network; and
carrying out detailed behavior planning based on the strategic behavior planning using at least one downstream planning component;
wherein at least one geometric behavior specification for the vehicle in the given traffic scene is generated as part of the strategic behavior planning by:
identifying at least one go zone that the vehicle may or should pass through in order to pursue the specified destination, and/or
identifying at least one no-go zone that the vehicle should avoid when pursuing the specified destination; and
wherein, as a result of the detailed behavior planning, at least one trajectory for the vehicle is generated, taking into account the at least one geometric behavior specification of the strategic behavior planning.

2. The method according to claim 1, wherein a unimodal or a multimodal deep learning foundation model is used as the neural network for the strategic behavior planning, wherein the foundation model is very large and has been pre-trained with extremely large data sets, in a self-supervised manner.

3. The method according to claim 1, wherein the at least one geometric behavior specification is provided in the form of a sequence of hit points, wherein each of the hit points is determined by location coordinates and: (i) a time specification and/or (ii) at least one state parameter for the vehicle including velocity and/or acceleration and/or orientation.

4. The method according to claim 1, wherein the at least one geometric behavior specification is provided in the form of a sequence of hit regions, wherein each hit region is determined by a location specification in the form of a polygon and: (i) a time interval and/or (ii) a time interval of at least one state parameter for the vehicle including velocity and/or acceleration and/or orientation.

5. The method according to claim 1, wherein the at least one geometric behavior specification is provided in the form of zones which are located in the given traffic scene and to each of which semantic information on a possible behavior of the vehicle in the zone is assigned, wherein the possible behavior of the vehicle is described using at least one state parameter including velocity and/or acceleration and/or orientation.

6. The method according to claim 1, wherein a prediction of a future development of the given traffic scene is taken into account in the strategic behavior planning.

7. The method according to claim 1, wherein the scene representation and/or a prediction of the future development of the given traffic scene, is taken into account in the detailed behavior planning.

8. The method according to claim 1, wherein the at least one trajectory is generated in a rule-based or optimization-based or sampling-based or tree-search-based or machine learning (ML)-based manner as a result of the detailed behavior planning, and the at least one geometric behavior specification is taken into account as a selection criterion or as an optimization criterion, when generating the at least one trajectory.

9. A computer-implemented system for planning a behavior of a vehicle in a given traffic scene, wherein the behavior planning pursues a specified destination, the system comprising:
a perception level configured to aggregate scene-specific information and generate at least one scene representation of the traffic scene;
at least one neural network which carries out strategic behavior planning based on the scene representation generated by the perception level; and
a downstream planning component which carries out detailed behavior planning based on the strategic behavior planning;
wherein the at least one neural network is trained to generate at least one geometric behavior specification for the vehicle in the given traffic scene as a result of the strategic behavior planning by:
identifying at least one go zone that the vehicle may or should pass through in order to pursue the specified destination, and/or
identifying at least one no-go zone that the vehicle should avoid when pursuing the specified destination, and
wherein the downstream planning component is configured to generate at least one trajectory for the vehicle as a result of the detailed behavior planning, taking into account the at least one geometric behavior specification of the strategic behavior planning.

10. The system according to claim 9, wherein the at least one neural network includes at at least one neural network the form of a DL foundation model for the strategic behavior planning.

11. The system according to claim 9, wherein the downstream planning component generates at least one trajectory in a rule-based, or optimization-based, or sampling-based, or tree-search-based, or or machine learning (ML)-based manner, as a result of the detailed behavior planning.

12. The system according to claim 10, wherein at least one further planning component, including a further neural network, is provided, which extracts planning-relevant information from the aggregated scene-specific information and provides the extracted information to the downstream planning component.
